(19) United States
(12) Patent Application Publication
(10) Pub. No.: US 2010/0332215 A1
(43) Pub. Date: Dec. 30, 2010

(54) METHOD AND APPARATUS FOR CONVERTING TEXT INPUT

(75) Inventor: Jari Pertti Tapani Alhonen, Beijing (CN)

Correspondence Address: Perman & Green, LLP, 99 Hawley Lane, Stratford, CT, 06614, US

(73) Assignee: NOKIA CORPORATION, Espoo (FI)

(21) Appl. No.: 12/492,590

(22) Filed: Jun. 26, 2009

(51) Int. Cl. G06F 17/28

(52) U.S. Cl. 704/3; 704/2

(57) ABSTRACT

A method includes detecting a group of characters input into an electronic device, the group of characters including a sequence of character sub-groups that are input in a first configuration, and converting the group of characters as a whole, from the first configuration to a second configuration such that a given character sub-group in the sequence of character sub-groups is converted at least by analyzing other character sub-groups that both precede and follow the given character sub-group in the sequence of character sub-groups.

### BACKGROUND

1. Field

The aspects of the disclosed embodiments generally relate to text and character input devices, and more particularly to devices for generating accented characters.

2. Brief Description of Related Developments

Vietnamese text is written in a script called Quõc Ng [symbol] , which like the English language is based on the latin script. However, Quõc Ng [symbol] is extended with numerous additional letters through the application of, for example, tonal accents and different phonemes. For example, in Quõc Ng [symbol] a first set of markers are used for the higher number of phonemes, and second set of markers are used for the six tones present in the Vietnamese language. Both the first set and second set of markers may be present in one character and all syllables are written spaced separately from each other as if they were separate words as can be seen in the sample 100 text in FIG. 1. The tonal markers and other phonome markers used in the Vietnamese language generally makes the number of characters rather large. The large number of characters may create problems, on for example, electronic devices with small or limited keypads. FIG. 2 is an example of how the same set of characters can represent six different words by using different accent markers to each character of the set. For example, the first column 200 represents the tones of the Vietnamese language, the second column 210 represents the characters and their respective accent markers and the third column 220 represents the words (in English) corresponding to the respective characters and their accent markers.

Generally, one way of writing Vietnamese using electronic devices, such as for example, mobile communication devices, is to use the numeric keys as ‘dead accent’ keys that are written after the character they are associated with. For example, to write the character ‘ [symbol] ’ in the Vietnamese language a user of the device has to press the key corresponding to the Latin script letter “a”, followed by the keys corresponding to the numbers “8” and “3”. Generally, special software is used to implement the Vietnamese character input scheme such as the one just described. The combination of keys that are pressed for obtaining the Vietnamese characters is not intuitive and depends on the software being used. As such, the users of the devices must memorize these non-standardized key combinations for the characters and the different tones used in the Vietnamese language.

Generally, on mobile electronic devices, such as mobile phones, the most common input style is multi-tapping (i.e. a method of typing with a keypad by pressing one button several times to find the correct alternative). The extra characters and their accent markers in, for example, the Vietnamese language, require a significant amount of tapping. For example, on one phone the Vietnamese characters ‘ [symbol] ’ may appear after tapping the key corresponding to the number “2” twice and the key corresponding to the number “4” five times where the “taps” on the number “2” key correspond to the Latin script letter and “taps” on the number “4” key correspond to the tonal accent marker. Generally, the methods of inputting, for example, Vietnamese text are so cumbersome that experienced users tend not to write the tones and accented letters at all, but write merely the Latin script letters. While experienced users can decipher this text rather easily, those not used to this style or writing do not understand such texts. Even those used to the non-accented writing style find reading properly accented text faster and easier.

In another example, a method of inputting text, such as for example, Vietnamese text, uses a predictive input system making use of nine keys to enter text without the use of multi-tapping. This predictive text input method for Vietnamese works in a similar manner as for the English language where users only press the key for each character in a word once and a lexicon is used to find the correct word for the inputted series of characters. In the predictive text input method the previous word(s) are used to help determine which word should come next in the series of words, to reduce the number of alternatives. Sometimes, but not always, the tonal accent markers have to be written separately, again assuming knowledge of which key corresponds to the desired tone. The predictive text input method can be problematic for users, where the language model fails to predict the right word and a new word must be added to the lexicon, despite the fact that the word, in most cases, is already in the lexicon. Even when the correct word is predicted, much of the time the user has to select the correct word from a menu as it may not be the default option.

An additional problem with accented text is created by the various encoding schemes used in mobile electronic devices. This causes the problem where occasionally the correctly typed accented text is not displayed correctly on the screen of the receiving device, but the additional characters including the accents appear as squares, garbled characters, or are otherwise unrecognizable. This problem, however, has an existing solution of determining and automatically converting the received message to a usable encoding. Yet the problem remains in older phones.

It would be advantageous to be able to easily and intuitively enter accented characters in a mobile electronic device.

### SUMMARY

The aspects of the disclosed embodiments are directed to at least a method, apparatus, user interface and computer program product. In one embodiment the method includes detecting an input of a group of characters input, where the group of characters includes a sequence of character sub-groups that are input in a first configuration, and converting the group of characters as a whole from the first configuration to a second configuration such that a given character sub-group in the sequence of character sub-groups is converted at least by analyzing other character sub-groups that both precede and follow the given character sub-group in the sequence of character sub-groups.

### BRIEF DESCRIPTION OF THE DRAWINGS

The foregoing aspects and other features of the embodiments are explained in the following description, taken in connection with the accompanying drawings, wherein:

FIG. 1 illustrates exemplary text including accents corresponding to at least tonal features of a predetermined language;

FIG. 2 illustrates exemplary words formed by using the same set of characters and applying different tonal accents;

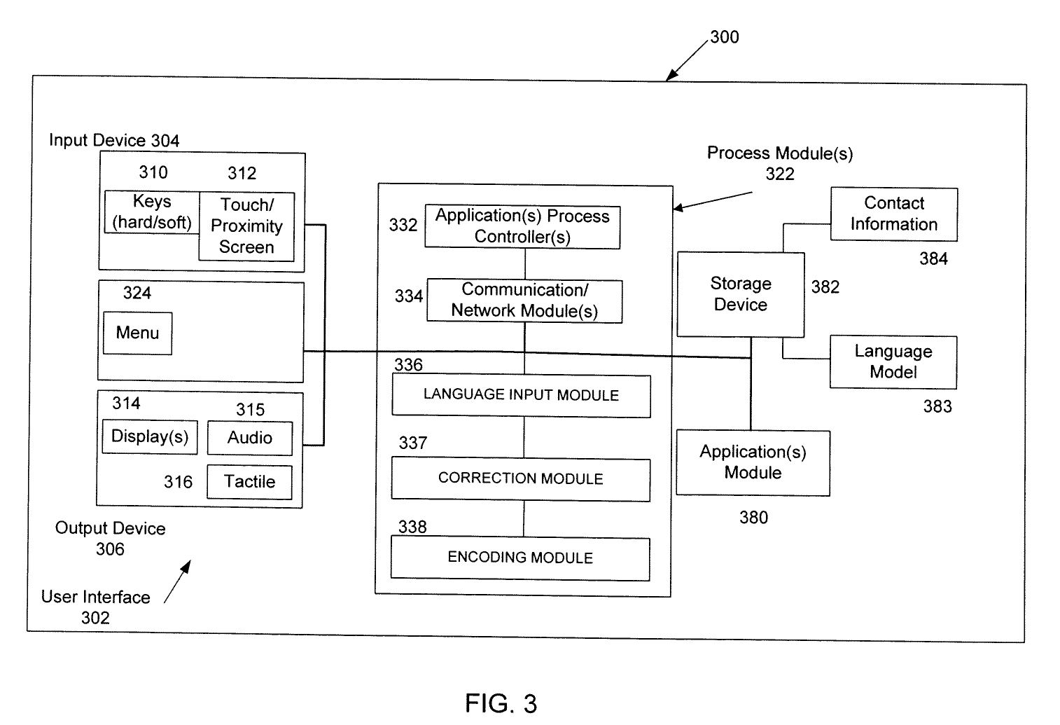

FIG. 3 shows a block diagram of a system in which aspects of the disclosed embodiments may be applied;

FIG. 4 illustrates a flow diagram in accordance with aspects of the disclosed embodiments;

FIGS. 5A-5C are exemplary screen shots of a display in accordance with aspects of the disclosed embodiments;

FIG. 6 illustrates a flow diagram in accordance with aspects of the disclosed embodiments;

FIGS. 7A and 7B are illustrations of exemplary devices that can be used to practice aspects of the disclosed embodiments;

FIG. 8 illustrates a block diagram of an exemplary system incorporating features that may be used to practice aspects of the disclosed embodiments; and

FIG. 9 is a block diagram illustrating the general architecture of an exemplary system in which the devices of FIGS. 7A and 7B may be used.

### DETAILED DESCRIPTION OF THE EMBODIMENT(s)

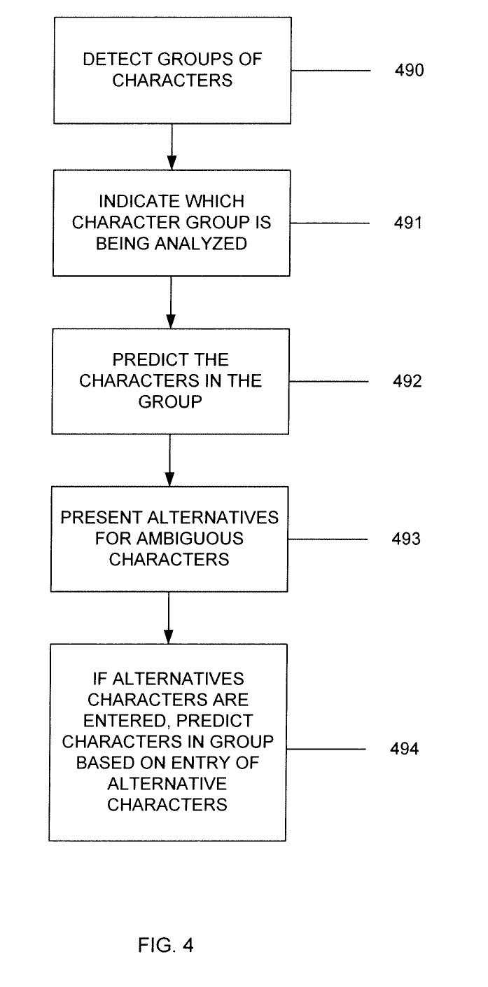

FIG. 3 illustrates one embodiment of a system 300 in which aspects of the disclosed embodiments can be applied. Although the disclosed embodiments will be described with reference to the embodiments shown in the drawings and described below, it should be understood that these could be embodied in many alternate forms. In addition, any suitable size, shape or type of elements or materials could be used. It is noted that the aspects of the disclosed embodiments are described herein with respect to the Vietnamese language for exemplary purposes only and that one or more aspects of the disclosed embodiments may be applied to any suitable language in a manner substantially similar to that described herein.

The exemplary embodiments allow for easy and intuitive inputting of accented characters into devices with small or otherwise limited keypads, such as mobile electronic devices. For example, an entire phrase or sentence is input into the system 300 using basic Latin script. The system 300 is configured to analyze the entire phrase or sentence and convert the entire phrase or sentence into an accented or toned version of the phrase or sentence (e.g. where each word in the phrase or sentence is translated to characters corresponding to one of the tones in, for example, the Vietnamese language or any other suitable language). The disclosed embodiments enable a language model that considers one or more adjacent words on both sides (e.g. preceding words and subsequent words) of a word to be recognized by the language model for providing a substantially error free conversion of the inputted text or characters. The substantially error free conversion of inputted text results in fewer and more relevant selections of “correct” alternatives when an error does occur when compared to the conventional predictive text inputting methods. It is noted that with the use of a good language model, it is likely that conversion errors would only occur in instances where rarely used words are input, in which case users will most likely be prepared to disambiguate these rare words.

FIG. 3 illustrates one example of a system 300 incorporating aspects of the disclosed embodiments. Generally, the system 300 includes a user interface 302, process module(s) 322, applications module(s) 380, and storage device(s) or memory devices 382 (also referred to herein as “computer readable storage medium(s)”). In alternate embodiments, the system 300 can include other suitable systems, devices and components that allow for conversion of inputted text into accented characters representing, for example, tones or other phonemes of a given language. The components described herein are merely exemplary and are not intended to encompass all components that can be included in the system 300. The system 300 can also include one or more processors or computer program products to execute the processes, methods, sequences, algorithms and instructions described herein.

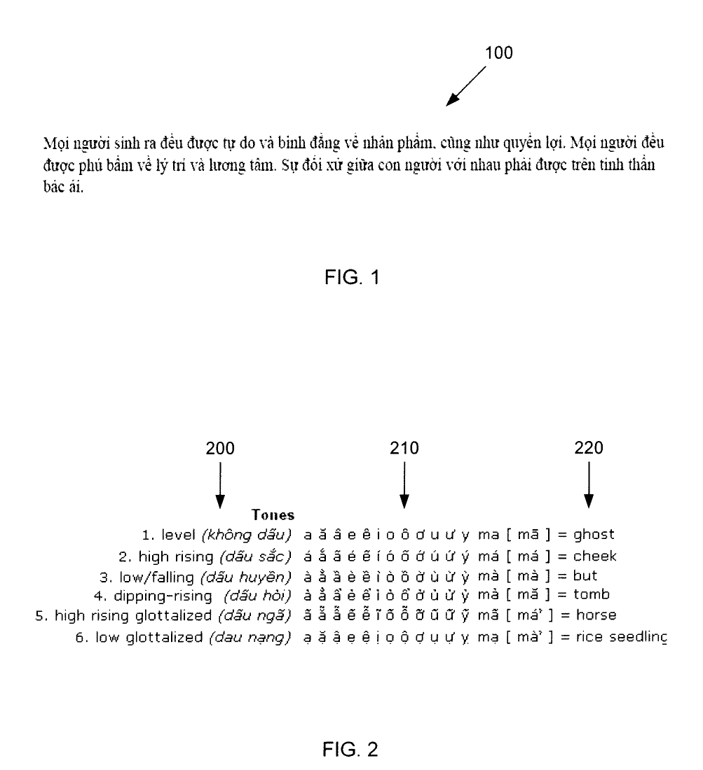

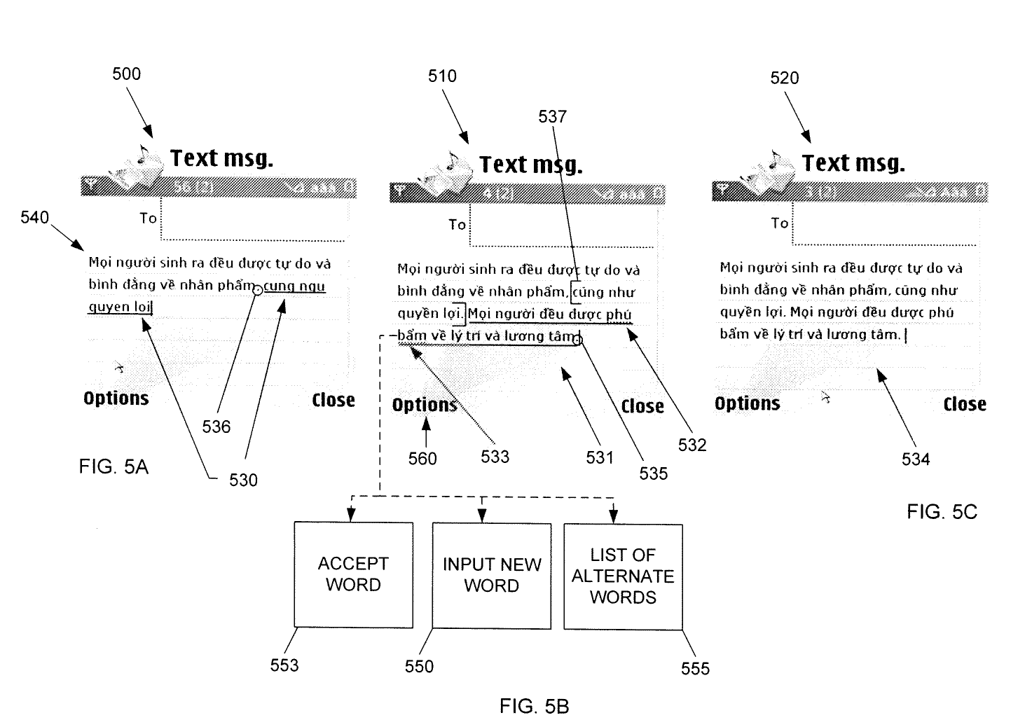

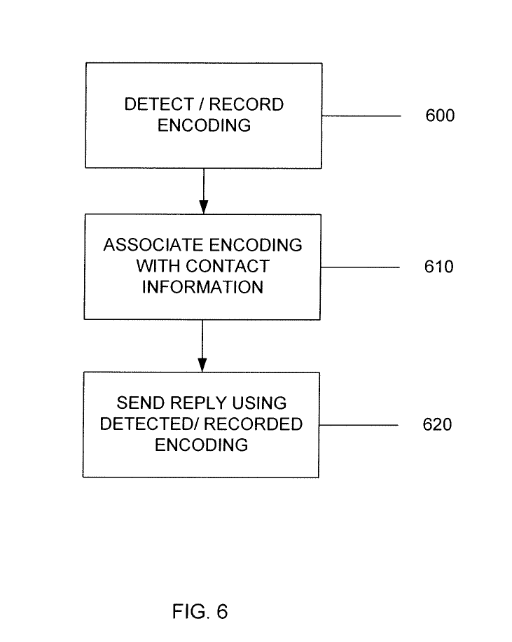

In one embodiment, the process module 322 includes a character input module 336 that allows for the inputting of one or more characters into the system 300. The character input module 336 may be configured to analyze groups of inputted characters for converting those groups of characters into accented text as shown in, for example, FIG. 1. The groups of characters may include any suitable number of words, phrases, sentences, paragraphs or any other suitable grouping of characters. The groups of characters may be detected by the character input module 336 (FIG. 4, Block 490) in any suitable manner such as by, for example, a detection of one or more end of group markers 435, 436 (FIGS. 5A, 5B). The end of group marker(s) 435, 436 may be any suitable marker(s) including, but not limited to, one or more types of punctuation marks (e.g. commas, periods, colons, semicolons, dashes, etc.). The end of group markers may be user definable through, for example, any suitable menu 324 of the system 300. For example, a suitable menu selection may be presented visually and/or aurally through, for example, the output device 306 for enabling a user to select one or more types of punctuation or other suitable markers for indicating the end of a character group.

As the characters in a group of characters are being input, the character input module 336 indicates in any suitable manner which characters are currently being analyzed or processed for conversion (FIG. 4, Block 491). For example, FIG. 5A illustrates an exemplary screen shot of the entry of a text message as presented on, for example, the display 314 of the system 300. In FIG. 5A a first group of characters 540 identified by the end of group marker 536 is shown as already being analyzed and converted into accented characters. The character input module 336 is configured to determine that the entry of a second group of characters 530 has begun through, for example, the detection of the end of group marker 536 or in any other suitable manner. When the character input module 336 determines a second group of characters is being entered, the character input module 336 begins analyzing the second group of characters. In this example, the character input module 336 is configured to highlight the characters 530 being analyzed in any suitable manner. Highlighting the characters being analyzed may include, but is not limited to, underlining, changing a font type, size or color and changing a background color. In one example, the character input module 336 continues to analyze the character group 530 until an end of group marker is detected such as the end of group marker 535 shown in FIG. 5B so that the entire character group is converted together. In other examples, a group of characters may be analyzed and converted if one or more words, phrases, etc. formed by the characters is disambiguous even though an end of group marker has not been detected.

The character input module 336 may have access to a language model 383 for predicting the words, phrases, etc. formed by the group of characters 430. The language model 383 may be any suitable model arranged to allow the prediction of words, phrases or any other combination of characters based on the inputted characters, such as those in the group of characters 530. As can be seen in FIG. 5A the group of characters is input as basic Latin script characters only (e.g. without tonal or other accents, which are added during the prediction of the words, phrases, etc. as described below). The language model 383 may be stored in any suitable storage of the system 300 such as, for example, the storage device 382. In other examples, the language model 382 may be configured as an application in the application module 380. Upon detection of the end of group marker 535, or when at least part of the phrase is disambiguous, the character input module 336 accesses the language model 383 for predicting one or more words based on the group of characters 530 input into the system 300. In one example, the character input module 336 not only analyzes characters before a given character to be predicted, but also analyzes characters after the given character when predicting and converting the given character. For example, when predicting individual words or syllables (or any other sub-grouping of characters, referred to herein collectively as “words”) in the group of characters, the character input module 336 may analyze the words in an order from the beginning of the phrase to the end of the phrase. For example, when predicting the word corresponding to the characters “cung” the character input module may consider the characters “ngu guyen loi” in the group of characters 530 and/or the already converted characters in the group of characters 540. When predicting the word corresponding to the characters “ngu”, the character input module 336 considers at least the characters “cung” located before the characters “ngu” and the characters “guyen loi” located after the characters “ngu”. When predicting the word corresponding to the characters “guyen”, the character input module 336 considers the characters “cung ngu” located before the characters “guyen” and the characters “loi” located after the characters “guyen”. The character input module 336 continues to predict each word or syllable in the group of characters 530 in this manner based on the language model 383 until the end of the group of characters is reached. The language model 383 is used by the character input module 336 to determine each word and their corresponding tonal and other phoneme accents based on the group of characters 530. FIG. 5B illustrates a screen shot including a predicted phrase 537 formed from the group of characters 530 which includes the tonal accents as well as other phoneme accents. In other examples the words may be analyzed by the character input module in any suitable order or simultaneously.

FIG. 5B also illustrates another group of characters 531, which has at least been partially analyzed by the character input module 336 using the language model 383. This group of characters 531 includes the tonal and other accents in accordance with, for example, the Vietnamese language. However, the group of characters includes one or more words 532, 533 that have been predicted with some uncertainty. The character input module 336 indicates these uncertain words on the display in any suitable manner such as the highlighting described above. In this example, the character input module 336 indicates the uncertain words 532, 533 by placing a broken or dashed line underneath the uncertain words 532, 533. This broken or dashed line may be colored, animated or otherwise configured to differentiate the uncertain words 532, 533 from the other words being analyzed in the group of characters 531.

A correction module 337, which in one embodiment is part of the process module 322 and in communication with the character input module 336, may present correction options for replacing the uncertain words 532, 533 if desired by the user. It is noted that while the correction module 337 and the character input module 336 are described as separate modules, in other examples they may be integrated together in a single module. The correction module 337 allows for the selection of any one or more of the uncertain words or syllables in any suitable manner. In one example, any suitable key(s) 310 of the system 300, such as a multifunction scroll key, may be used to cycle through or otherwise select, in any desired order, the uncertain words 532, 533 to be corrected. In other examples, an uncertain word 532, 533 to be corrected may be selected through a touch/proximity screen 312 of the system 300. In still other examples, the uncertain words 532, 533 to be corrected may be selected using speech recognition or other aural features of the system 300. Upon selection of an uncertain word 532, 533 to be corrected, the correction module 337 displays an option for accepting the word 553, replacing the uncertain word with a new word 550 and/or provides a list of alternate words 555 that may replace the uncertain word 532, 533. It is noted that the list of alternate words 555 may be presented in any suitable order such as, for example, an order from most likely words to least likely words for replacing the uncertain words 532, 533. It is noted that these correction options may be presented automatically upon selection of the uncertain word 532, 533 or upon further selection of an options feature 560 of the system 300. It is also noted that if the entire group of characters 531 is ambiguous or uncertain after the conversion of the characters, the correction module 337 may present replacement words, phrases, paragraphs, etc. corresponding to the ambiguous group of characters in a manner substantially similar to that described above with respect to the replacement of the individual words 532, 533.

In one example, as each uncertain word 532, 533 is accepted 553 (e.g. without modification) or replaced either with a new word 550 or a word selected from a list of alternate words 555, the correction module 337 records in any suitable storage, such as storage device 382, the corrections that were or were not made and the context in which the replacement word (i.e. the word replacing the uncertain word 532, 533) was used. It is noted that when the uncertain word is replaced with a new word, that new word may be added to lexicon corresponding to the language model 383 if that word is not already present in the lexicon. In one example, the information regarding the acceptance or replacement of the uncertain words 532, 533 recorded by the correction module 337 may be used to modify the language model 383 to allow for better prediction of these words during analyzation of subsequent groups of characters. In other examples, the information regarding the acceptance or replacement of the uncertain words 532, 533 may be used by the correction module 337 to present more accurate replacements for uncertain words. It is noted that the options for accepting the uncertain word, replacing the uncertain word with a new word or replacing the uncertain word with a word selected from a list of alternate words may be presented through, for example, the output device 306 in any suitable manner. In one example, the acceptance or replacement options may be presented visually through, for example, pop-up windows and lists presented on the display 314. In other examples, the acceptance or replacement options may be presented aurally such as through audio output 315.

In one example, other words in the group of characters 531 may be changed or replaced even though they are not selected by the character input module 336 as being uncertain. For example, the keys 310 and/or touch/proximity screen 312 may allow for selection of any suitable word in the group of words in a manner substantially similar to that described above. In one example, upon selection of the desired word, the options feature 560 of the system may be selected for presentation of the correction options, such as inputting a new word 550 and selecting an alternate word from a list 555 in the manner described above. In another example, the word correction options 550, 555 may be presented automatically upon selection of the desired word.

When one or more of the uncertain words 532, 533 and/or other user selected words are replaced, the character input module 336 re-analyzes at least a portion of the group of characters 531 to substantially ensure the accuracy of the character prediction and changes the predicted characters, as needed, based on the newly inputted replacement word(s) and the context in which they are used. In one example, the character input module 336 may use the language model 383 to re-analyze other parts of the group of words 531 that have not yet been corrected. For example, assuming that one or more of the uncertain words 532, 533 are being replaced, it is noted that the words that are passed over when scrolling through the uncertain words 532, 533, such as for example, the words “M [symbol] i ng [symbol] I [symbol] êu [symbol] c” are assumed to be correct such that only the words, such as the words “vê lý trí và [symbol] ng tâm” following the replaced uncertain word(s) 532, 533 are re-analyzed based on at least the newly inputted replacement word and/or the context in which the newly inputted replacement word is used. The character input module 336 may stop analyzing the group of characters 531 when there are no longer any uncertain words identified in the group of characters 531, at which point the highlighting (in this example the highlighting is the underlining shown in FIG. 5B) of the group of characters is removed as shown in FIG. 5C and the words are displayed in their accepted form 534.

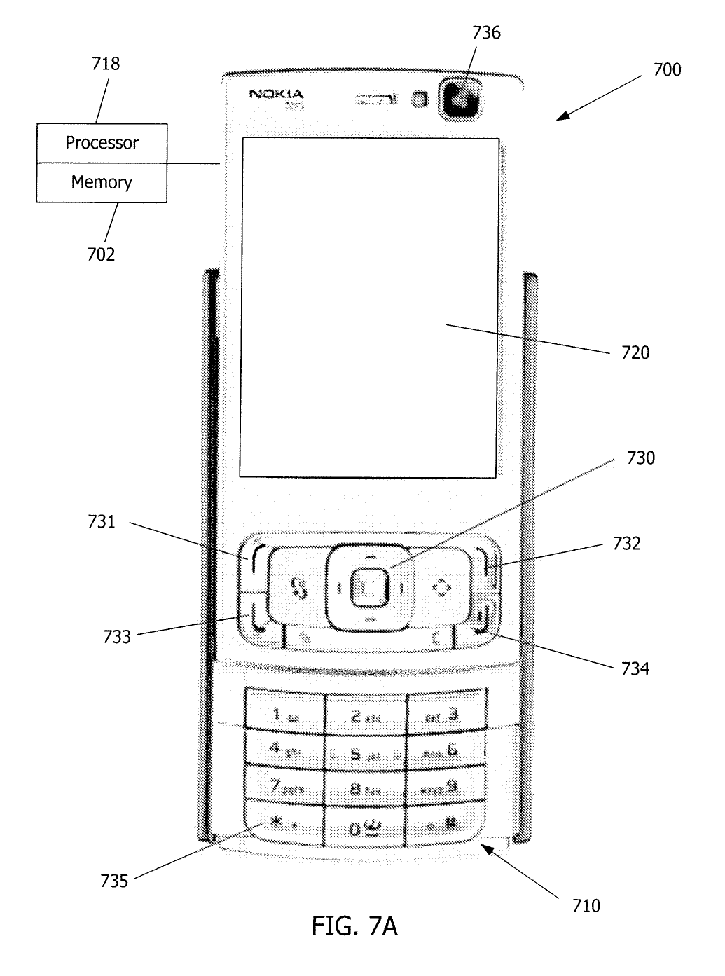

In one embodiment, the process module 322 includes an encoding module 338. The encoding module 338 may be configured to detect and record a type of encoding for any suitable messages or other communications received by the system 300 (FIG. 6, Block 600). In one example, the encoding module is configured to associate the type of encoding with contact information 384 corresponding to the originator of the message or other communication (FIG. 6, Block 610). The contact information 384 may be stored in any suitable storage of the system, such as storage device 382. As a non-limiting example, when a text message (or any other suitable message) is received by the system 300 from, for example, a mobile communication device (or other suitable device), the encoding module 338 records the type of encoding corresponding to the received text message and associates that encoding type to the phone number or other suitable contact information 384 corresponding to the mobile communication device from which the message was received. When a reply is generated to the received message, the reply is sent by the system 300 using the same encoding used in the received message to ensure that the reply message (including any accented letters present in the reply message) can be read using the mobile communication device that sent the originally received message (FIG. 6, Block 620).

Referring to FIG. 3, the input device(s) 304 are generally configured to allow a user to input data, instructions and commands to the system 300. In one embodiment, the input device 304 can be configured to receive input commands remotely or from another device that is not local to the system 300. The input device 304 can include devices such as, for example, keys 310, touch screen 312 and menu 324. The input devices 304 could also include a camera device (not shown) or other such other image capturing system. In alternate embodiments the input device can comprise any suitable device(s) or means that allows or provides for the input and capture of data, information and/or instructions to a device, as described herein.

The output device(s) 306 are configured to allow information and data to be presented to the user via the user interface 302 of the system 300 and can include one or more devices such as, for example, a display 314, audio device 315 or tactile output device 316. In one embodiment, the output device 306 can be configured to transmit output information to another device, which can be remote from the system 300. While the input device 304 and output device 306 are shown as separate devices, in one embodiment, the input device 304 and output device 306 can be combined into a single device, and be part of and form, the user interface 302. The user interface 302 can be used to receive and display information pertaining to inputting and conversion of text as described herein. While certain devices are shown in FIG. 3, the scope of the disclosed embodiments is not limited by any one or more of these devices, and an exemplary embodiment can include, or exclude, one or more devices.

The process module 322 is generally configured to execute the processes and methods of the disclosed embodiments. The application process controller 332 can be configured to interface with the applications module 380, for example, and execute applications processes with respects to the other modules of the system 300. In one embodiment the applications module 380 is configured to interface with applications that are stored either locally to or remote from the system 300 and/or web-based applications. The applications module 380 can include any one of a variety of applications that may be installed, configured or accessible by the system 300, such as for example, office, business, media players and multimedia applications, web browsers and maps. In alternate embodiments, the applications module 380 can include any suitable application. The communication module 334 shown in FIG. 3 is generally configured to allow the device to receive and send communications and messages, such as text messages, chat messages, multimedia messages, video and email, for example. The communications module 334 is also configured to receive information, data and communications from other devices and systems.

In one embodiment, the applications module 380 can also include a voice recognition system that includes a text-to-speech module that allows the user to receive and input voice commands, prompts and instructions, through a suitable audio input device.

The user interface 302 of FIG. 3 can also include menu systems 324 coupled to the processing module 322 for allowing user input and commands. The processing module 322 provides for the control of certain processes of the system 300 including, but not limited to, the controls for selecting files and objects, accessing and opening forms, and entering and viewing data in the forms in accordance with the disclosed embodiments. The menu system 324 can provide for the selection of different tools and application options related to the applications or programs running on the system 300 in accordance with the disclosed embodiments. In the embodiments disclosed herein, the process module 322 receives certain inputs, such as for example, signals, transmissions, instructions or commands related to the functions of the system 300, such as messages, notifications and state change requests. Depending on the inputs, the process module 322 interprets the commands and directs the process control 332 to execute the commands accordingly in conjunction with the other modules.

Referring to FIGS. 3 and 6B, in one embodiment, the user interface of the disclosed embodiments can be implemented on or in a device that includes a touch screen display, proximity screen device or other graphical user interface.

In one embodiment, the display 314 can be integral to the system 300. In alternate embodiments the display may be a peripheral display connected or coupled to the system 300. A pointing device, such as for example, a stylus, pen or simply the user's finger may be used with the display 314. In alternate embodiments any suitable pointing device may be used. In other alternate embodiments, the display may be a suitable display, such as for example a flat display 314 that is typically made of a liquid crystal display (LCD) with optional back lighting, such as a thin film transistor (TFT) matrix capable of displaying color images.

The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to include that a user only needs to be within the proximity of the device to carry out the desired function.

Similarly, the scope of the intended devices is not limited to single touch or contact devices. Multi-touch devices, where contact by one or more fingers or other pointing devices can navigate on and about the screen, are also intended to be encompassed by the disclosed embodiments. Non-touch devices are also intended to be encompassed by the disclosed embodiments. Non-touch devices include, but are not limited to, devices without touch or proximity screens, where navigation on the display and menus of the various applications is performed through, for example, keys 310 of the system or through voice commands via voice recognition features of the system.

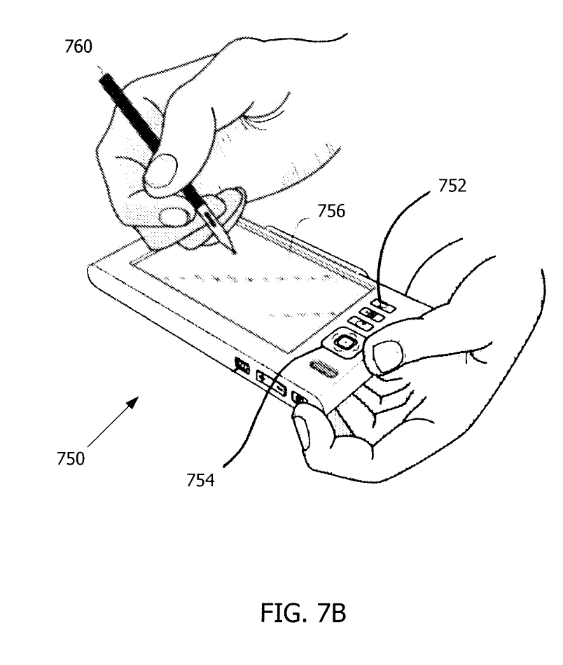

Some examples of devices on which aspects of the disclosed embodiments can be practiced are illustrated with respect to FIGS. 7A-7B. The devices are merely exemplary and are not intended to encompass all possible devices or all aspects of devices on which the disclosed embodiments can be practiced. The aspects of the disclosed embodiments can rely on very basic capabilities of devices and their user interface. Buttons or key inputs can be used for selecting the various selection criteria and links, and a scroll function can be used to move to and select item(s).

FIG. 7A illustrates one example of a device 700 that can be used to practice aspects of the disclosed embodiments. As shown in FIG. 7A, in one embodiment, the device 700 may have a keypad 710 as an input device and a display 720 for an output device. The keypad 710 may include any suitable user input devices such as, for example, a multi-function/scroll key 730, soft keys 731, 732, a call key 733, an end call key 734 and alphanumeric keys 735. In one embodiment, the device 700 can include an image capture device 736 such as a camera as a further input device. The display 720 may be any suitable display, such as for example, a touch screen display or graphical user interface. The display may be integral to the device 700 or the display may be a peripheral display connected or coupled to the device 700. A pointing device, such as for example, a stylus, pen or simply the user's finger may be used in conjunction with the display 720 for cursor movement, menu selection and other input and commands. In alternate embodiments any suitable pointing or touch device, or other navigation control may be used. In other alternate embodiments, the display may be a conventional display. The device 700 may also include other suitable features such as, for example a loud speaker, tactile feedback devices or connectivity port. The mobile communications device may have a processor 718 connected or coupled to the display for processing user inputs and displaying information on the display 720. A memory 702 may be connected to the processor 718 for storing any suitable information, data, settings and/or applications associated with the mobile communications device 700.

Although the above embodiments are described as being implemented on and with a mobile communication device, it will be understood that the disclosed embodiments can be practiced on any suitable device incorporating a processor, memory and supporting software or hardware. For example, the disclosed embodiments can be implemented on various types of music, gaming and multimedia devices. In one embodiment, the system 300 of FIG. 3 may be for example, a personal digital assistant (PDA) style device 750 illustrated in FIG. 7B. The personal digital assistant 750 may have a keypad 752, cursor control 754, a touch screen display 756, and a pointing device 760 for use on the touch screen display 756. In still other alternate embodiments, the device may be a personal computer, a tablet computer, touch pad device, Internet tablet, a laptop or desktop computer, a mobile terminal, a cellular/mobile phone, a multimedia device, a personal communicator, a television set top box, or any other suitable device capable of containing for example a display 314 shown in FIG. 3, and supported electronics such as the processor 718 and memory 702 of FIG. 7A. In one embodiment, these devices will be Internet enabled and include GPS and map capabilities and functions.

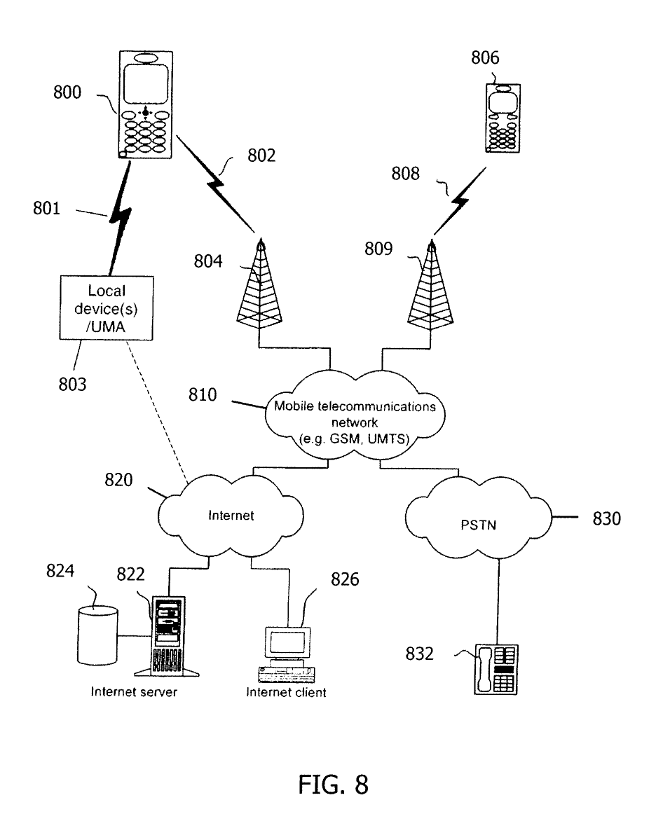

In the embodiment where the device 700 comprises a mobile communications device, the device can be adapted for communication in a telecommunication system, such as that shown in FIG. 8. In such a system, various telecommunications services such as cellular voice calls, worldwide web/wireless application protocol (www/wap) browsing, cellular video calls, data calls, facsimile transmissions, data transmissions, music transmissions, multimedia transmissions, still image transmission, video transmissions, electronic message transmissions and electronic commerce may be performed between the mobile terminal 800 and other devices, such as another mobile terminal 806, a line telephone 832, a personal computer (Internet client) 826 and/or an internet server 822.

It is to be noted that for different embodiments of the mobile device or terminal 800, and in different situations, some of the telecommunications services indicated above may or may not be available. The aspects of the disclosed embodiments are not limited to any particular set of services or communication, protocol or language in this respect.

The mobile terminals 800, 806 may be connected to a mobile telecommunications network 810 through radio frequency (RF) links 802, 808 via base stations 804, 809. The mobile telecommunications network 810 may be in compliance with any commercially available mobile telecommunications standard such as for example the global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 810 may be operatively connected to a wide-area network 820, which may be the Internet or a part thereof. An Internet server 822 has data storage 824 and is connected to the wide area network 820. The server 822 may host a worldwide web/wireless application protocol server capable of serving worldwide web/wireless application protocol content to the mobile terminal 800. The mobile terminal 800 can also be coupled to the Internet 820. In one embodiment, the mobile terminal 800 can be coupled to the Internet 820 via a wired or wireless link, such as a Universal Serial Bus (USB) or Bluetooth™ connection, for example.

A public switched telephone network (PSTN) 830 may be connected to the mobile telecommunications network 810 in a familiar manner. Various telephone terminals, including the stationary telephone 832, may be connected to the public switched telephone network 830.

The mobile terminal 800 is also capable of communicating locally via a local link 801 to one or more local devices 803. The local links 801 may be any suitable type of link or piconet with a limited range, such as for example Bluetooth™, a USB link, a wireless Universal Serial Bus (WUSB) link, an IEEE 802.11 wireless local area network (WLAN) link, an RS-232 serial link, etc. The local devices 803 can, for example, be various sensors that can communicate measurement values or other signals to the mobile terminal 800 over the local link 801. The above examples are not intended to be limiting, and any suitable type of link or short range communication protocol may be utilized. The local devices 803 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 800 may thus have multi-radio capability for connecting wirelessly using mobile communications network 810, wireless local area network or both. Communication with the mobile telecommunications network 810 may also be implemented using WiFi, Worldwide Interoperability for Microwave Access, or any other suitable protocols, and such communication may utilize unlicensed portions of the radio spectrum (e.g. unlicensed mobile access (UMA)).

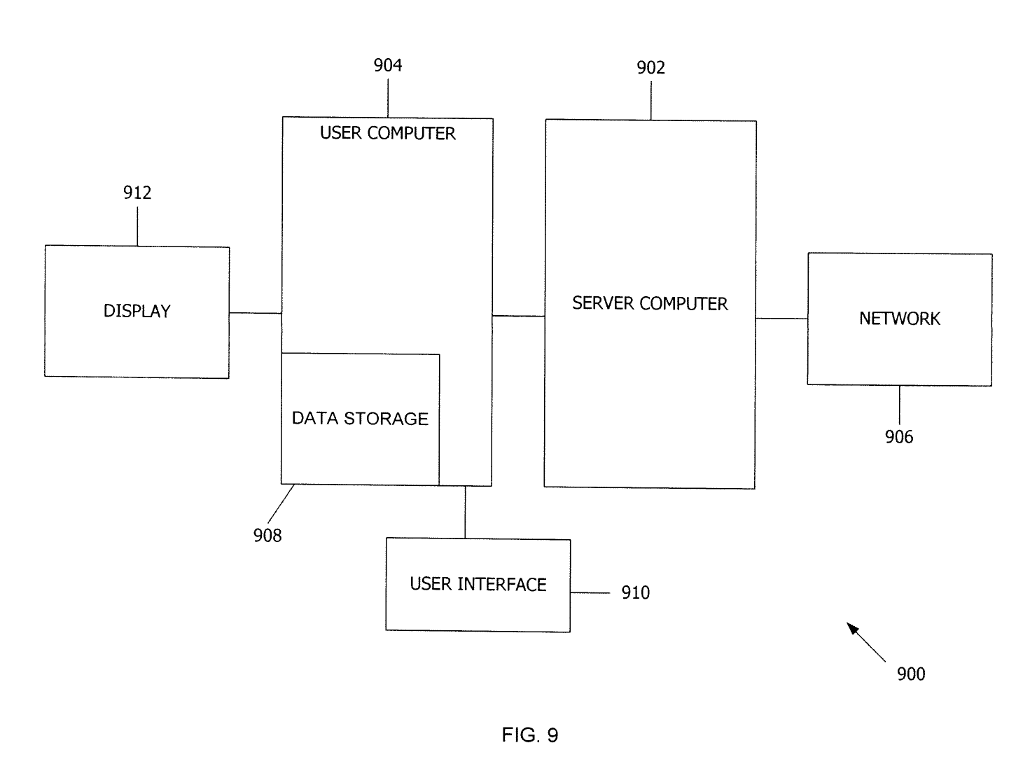

The disclosed embodiments may also include software and computer programs incorporating the process steps and instructions described above. In one embodiment, the programs incorporating the process steps described herein can be executed in one or more computers. FIG. 9 is a block diagram of one embodiment of a typical apparatus 900 incorporating features that may be used to practice aspects of the invention. The apparatus 900 can include computer readable program code means for carrying out and executing the process steps described herein. In one embodiment the computer readable program code is stored in a computer readable storage medium, such as for example a memory. In alternate embodiments the computer readable program code can be stored in memory or memory medium that is external to, or remote from, the apparatus 900. The memory can be direct coupled or wireless coupled to the apparatus 900. As shown, a computer system 902 may be linked to another computer system 904, such that the computers 902 and 904 are capable of sending information to each other and receiving information from each other. In one embodiment, computer system 902 could include a server computer adapted to communicate with a network 906. Alternatively, where only one computer system is used, such as computer 904, computer 904 will be configured to communicate with and interact with the network 906. Computer systems 902 and 904 can be linked together in any conventional manner including, for example, a modem, wireless, hard wire connection, or fiber optic link. Generally, information can be made available to both computer systems 902 and 904 using a communication protocol typically sent over a communication channel or other suitable connection or line, communication channel or link. In one embodiment, the communication channel comprises a suitable broad-band communication channel. Computers 902 and 904 are generally adapted to utilize program storage devices embodying machine-readable program source code, which is adapted to cause the computers 902 and 904 to perform the method steps and processes disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM”) floppy disks and semiconductor materials and chips.

Computer systems 902 and 904 may also include a microprocessor for executing stored programs. Computer 904 may include a data storage device 908 on its program storage device for the storage of information and data. The computer program or software incorporating the processes and method steps incorporating aspects of the disclosed embodiments may be stored in one or more computers 902 and 904 on an otherwise conventional program storage device. In one embodiment, computers 902 and 904 may include a user interface 910, and/or a display interface 912 from which aspects of the invention can be accessed. The user interface 910 and the display interface 912, which in one embodiment can comprise a single interface, can be adapted to allow the input of queries and commands to the system, as well as present the results of the commands and queries, as described with reference to FIG. 3, for example.

The aspects of the disclosed embodiments provide for inputting basic Latin characters and converting those Latin characters into accented characters corresponding to, for example, tones of a predetermined language. Aspects of the disclosed embodiments provide a system and method that uses a language model that allows for the analyzation of words within a string of words as a group. For example, the system and method analyzes whole phrases, sentences or paragraphs, as a group by considering one or more words, which are already converted and located before a word being analyzed and one or more words located after the word being analyzed to substantially ensure that each word in the phrase, sentence or paragraph is accurately converted into the accented characters. Other aspects of the disclosed embodiments substantially ensure that the accented characters can be read by other electronic devices by, for example, recording a type of encoding associated with messages received by the system 300 and using that same encoding when sending messages back to the other electronic device.

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A method comprising:
detecting an input of a group of characters in an electronic device, the group of characters including a sequence of character sub-groups that are input in a first configuration; and
converting the group of characters as a whole, from the first configuration into a second configuration, wherein a given character sub-group in the sequence of character sub-groups is converted at least by analyzing other character sub-groups that both precede and follow the given character sub-group in the sequence of character sub-groups.

2. The method of claim 1, wherein the first configuration comprises a basic Latin script and the second configuration comprises accented characters corresponding to tones and phonemes of a predetermined language.

3. The method of claim 1, further comprising detecting an end of group marker identifying an end of the group of characters, where the converting of the group of characters begins only after detection of the end of group marker.

4. The method of claim 1, further comprising analyzing each character sub-group as the input of the character sub-groups into the electronic device is detected and converting one or more of the character sub-groups as the one or more sub-groups become disambiguous based on other character sub-groups preceding and following the one or more character sub-groups in the sequence of character sub-groups.

5. The method of claim 1, wherein the group of characters comprises one or more of an entire phrase, an entire sentence and an entire paragraph and the character sub-groups comprise one or more of individual words and individual syllables.

6. The method of claim 1, further comprising highlighting on a display of the electronic device character sub-groups whose conversion is uncertain, where the highlighted character sub-groups are selectable for one of acceptance or replacement with a replacement character sub-group.

7. The method of claim 6, further comprising recording, in a memory of the electronic device, one or more of corrections that were or were not made to uncertain sub-groups and a context in which the replacement character sub-group was used.

8. The method of claim 7, further comprising one or more of:
modifying a language model stored in the electronic device to allow more accurate conversion of the uncertain character sub-groups during conversion of subsequent groups of characters including the uncertain character sub-groups; and
modifying a list of replacement character sub-groups based on information regarding the acceptance or replacement of the uncertain character sub-groups to present more accurate replacements for uncertain character sub-groups during subsequent replacement of the uncertain character sub-groups.

9. The method of claim 6, wherein when a highlighted character sub-group is replaced, the method further comprising verifying the conversion by re-analyzing at least a portion of the group of characters based on a corresponding replacement sub-group.

10. The method of claim 1, further comprising:
sending a message to a second electronic device, the message including a converted group of characters; and
encoding the message with an encoding previously obtained from a message received from the second electronic device.

11. A computer program product comprising computer readable code means stored in a computer readable storage medium, the computer readable code means configured to execute the method steps according to claim 1.

12. An apparatus comprising:
a character input detection device configured to detect an input of a group of characters, where the group of characters includes a sequence of character sub-groups that are input in a first configuration; and
at least processor coupled to the character input detection device, the at least one processor being configured to
convert the group of characters as a whole from the first configuration to a second configuration such that a given character sub-group in the sequence of character sub-groups is converted at least by analyzing other character sub-groups that both precede and follow the given character sub-group in the sequence of character sub-groups.

13. The apparatus of claim 12, wherein the first configuration comprises a basic Latin script and the second configuration comprises accented characters corresponding tones and phonemes of a predetermined language.

14. The apparatus of claim 12, wherein the at least one processor is further configured to detect an end of group marker identifying an end of the group of characters, where the converting of the group of characters begins only after detection of the end of group marker.

15. The apparatus of claim 12, wherein the at least one processor is further configured to analyze each character sub-group as the input of the character sub-groups into the apparatus is detected and convert one or more of the character sub-groups as the one or more sub-groups become disambiguous based on other character sub-groups preceding and following the one or more character sub-groups in the sequence of character sub-groups.

16. The apparatus of claim 12, further comprising:
a display coupled to the at least one processor; and
wherein the at least one processor is further configured to highlight, on the display, character sub-groups whose conversion is uncertain, and allow selectability of the highlighted character sub-groups for one of acceptance or replacement with a replacement character sub-group.

17. The apparatus of claim 16, the at least one processor being further configured to record one or more corrections that were or were not made to uncertain sub-groups and a context in which the replacement character sub-group was used.

18. The apparatus of claim 17, wherein the at least one processor is further configured to:
modify a language model to allow more accurate conversion of the uncertain character sub-groups during conversion of subsequent groups of characters including the uncertain character sub-groups; and/or
modify a list of replacement character sub-groups based on information regarding the acceptance or replacement of the uncertain character sub-groups to present more accurate replacements for uncertain character sub-groups during subsequent replacement of the uncertain character sub-groups.

19. A user interface comprising:
an character input detection device configured to detect an input of a group of characters into an electronic device, where the group of characters includes a sequence of character sub-groups that are input in a first configuration; and
at least one processor configured to and
convert the group of characters as a whole from the first configuration to a second configuration such that a given character sub-group in the sequence of character sub-groups is converted at least by analyzing other character sub-groups that both precede and follow the given character sub-group in the sequence of character sub-groups.

20. The user interface of claim 19, wherein the first configuration comprises a basic Latin script and the second configuration comprises accented characters corresponding tones and phonemes of a predetermined language.
